(19) United States
(12) Patent Application Publication
(10) Pub. No.: US 2024/0202819 A1
(43) Pub. Date: Jun. 20, 2024

(54) Property Analytics System

(71) Applicant: Uplist LLC, Bellevue, WA (US)

(72) Inventor: Jeffrey James Bell, Yarrow Point, WA (US)

(21) Appl. No.: 18/543,962

(22) Filed: Dec. 18, 2023

Related U.S. Application Data
(60) Provisional application No. 63/433,700, filed on Dec. 19, 2022.

(51) Int. Cl. G06Q 40/03; G06Q 30/0201; G06Q 30/0601

(52) U.S. Cl. CPC G06Q 40/03; G06Q 30/0206; G06Q 30/0641

(57) ABSTRACT

A property analytics system as disclosed herein provides analytic trends regarding property listings. To that end, the system generates a listing page for a property and includes a code that uniquely identifies the property. The listing page also includes details related to the property such as a property value. A request is received from a user that includes the code. That code in turn is used to retrieve data indicative of a value of the property and a loan term. In addition, information indicative of credit assigned to the property is retrieved also based on the code. A pricing engine determines a principal payment based on the credit and data indicative of a real-time rate. The principal payment information is sent for display on the user device.

### CROSS-REFERENCE TO RELATED APPLICATIONS

This application is a Nonprovisional of U.S. 63/433,700 filed Dec. 19, 2022, entitled, “Real Estate Listing Analytics,” which is incorporated herein by reference in its entirety.

### BACKGROUND

In recent years, property listing services have become much more accessible to potential buyers using on-line services such as Redfin and Zillow. Therefore, potential buyers are much more facile with applying technology to the search and purchase of property. One aspect of that process has not advanced to allow users to easily compare pricing. In particular, the process of determining property pricing in real time that accounts for rate fluctuations and seller incentives remains a tedious and manual process.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 is a diagram illustrating an example system for providing property listing content that may be used in accordance with the present description.

FIG. 2 is a diagram illustrating a flow diagram of the listing service in accordance with an aspect to the disclosed subject matter that may be used in accordance with the present description.

FIG. 3 is a diagram illustrating an example user interface to create a new listing that may be used in accordance with the present description.

FIG. 4 is a diagram illustrating an example of a printed output that may be left at a property that may be used in accordance with the present description.

FIG. 5 is a diagram illustrating a user interface including fields that may be edited for the listing that may be used in accordance with the present description.

FIG. 6 is a diagram illustrating an a user visiting a property may scan a QR code to access rate and payment information on a user device that may be used in accordance with the present description.

FIG. 7 is an example user interface illustrating output in response to a request for rate and pricing information that may be used in accordance with the present description.

FIG. 8 is a flowchart illustrating an example process that may be used in accordance with the present description.

FIG. 9 is a diagram illustrating an example computing system that may be used in accordance with the present description.

### DETAILED DESCRIPTION

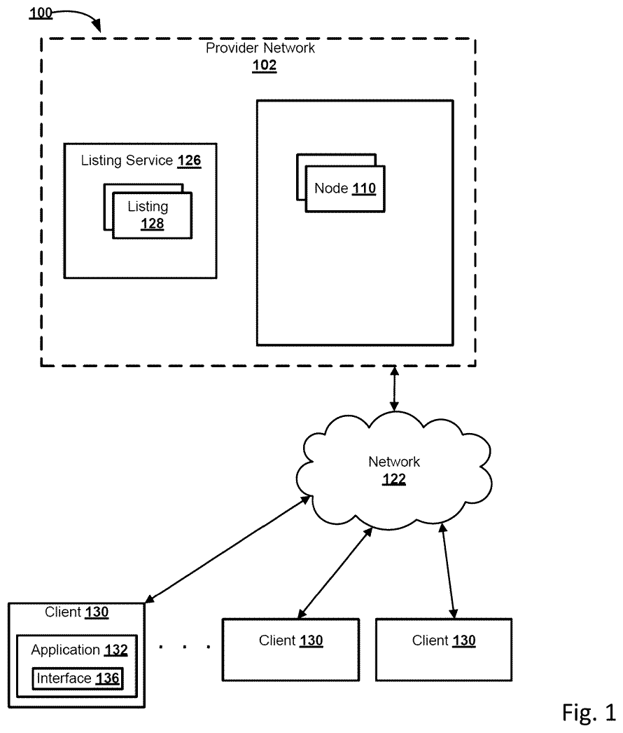

FIG. 1 is a schematic diagram showing an example system 100 for providing real estate listing content. The system 100 may comprise a provider network 102, a listing service 126, and a plurality of client devices 130. The provider network 102, the listing service 126, and the plurality of client devices 130 may communicate with each other via one or more networks 122.

In some embodiments, the listing service 126 may be implemented as part of the provider network 102. In other embodiments, the listing service 126 may be managed by a separate service provider than a service provider of the provider network 102. It should also be understood that the provider network 102 may provide additional content services separate from the content service 126.

The listing service 126 may comprise an analytics service as discussed more fully here in. The analytics service may be configured to maintain a variety of data items such as real estate listing information, mortgage information, tax information, etc. The listing service 126 may be configured to provide analytics data across a plurality of users and listing to track interactions with users over a variety of geographies and neighborhoods to determine how adjusting various listing parameter such as seller credits or lender credits and interest rates impacts buyer interest in various price level and geographic areas in just one example.

The provider network 102 may be located at a data center, such as a single premises, or be distributed throughout different geographic locations (e.g., at several premises). The provider network 102 may provide the services via the one or more networks 122. The network 122 comprise a variety of network devices, such as routers, switches, multiplexers, hubs, modems, bridges, repeaters, firewalls, proxy devices, and/or the like. The network 122 may comprise physical links, such as coaxial cable links, twisted pair cable links, fiber optic links, a combination thereof, and/or the like. The network 122 may comprise wireless links, such as cellular links, satellite links, Wi-Fi links and/or the like.

The provider network 102 may further comprise a processing service. The processing service 108 may be configured to provide processing for a variety of services, such as the services of the provider network 102. The processing service may comprise a plurality of processing nodes 110 (e.g., as a service). The plurality of processing nodes 110 may process tasks associated with a message service 106. The plurality of processing nodes 112 may be implemented as one or more computing devices, one or more processors, one or more virtual computing instances, a combination thereof, and/or the like.

The plurality of processing nodes 110 may be implemented by one or more computing devices. The one or more computing devices may comprise virtualized computing instances. The virtualized computing instances may comprise a virtual machine, such as an emulation of a computer system, operating system, server, and/or the like. A virtual machine may be loaded by a computing device based on a virtual image and/or other data defining specific software (e.g., operating systems, specialized applications, servers) for emulation. Different virtual machines may be loaded and/or terminated on the one or more computing devices as the demand for different types of processing services changes. A hypervisor may be implemented to manage the use of different virtual machines on the same computing device.

The plurality of processing nodes 110 may comprise nodes associated with providing specific services (e.g., processing tasks). The nodes may be dedicated to providing these specific services. For example, the plurality of processing nodes 110 may implement the listing service and/or that analytic service, and/or the like. In some implementations, these services may be implemented as dedicated computing devices, dedicated processors, dedicated virtual machine instances, and/or the like. In other implementations, a variety of different nodes may implement any of the functions associated with these services.

As described in detail below, the client devices 130 may provide input to the analytics service and/or the listing service with the input affecting the analytics and the listing information provided to the users.

The plurality of client devices 130 may access the services of the provider network 102. The plurality of client devices 130 may comprise any type of computing device, such as a mobile device, a tablet device, laptop, a computing station, a smart device (e.g., smart apparel, smart watch, smart speaker, smart glasses), a virtual reality headset, a gaming device, a set top box, digital streaming device, robot, and/or the like. The plurality of client devices 130 may be associated with one or more users. A single user may use one or more of the plurality of client devices 130 to access the provider network 102. The plurality of client devices 130 may travel to a variety of locations and use different networks to access the provider network 102.

An example client device 130 may comprise a listing app 132. The app 132 outputs (e.g., display, render, present) content to a user. The content may comprise videos, audio, comments, textual data and/or the like. The app 132 may also provide a menu for navigating a variety of content. The app may comprise an interface 136 for communicating with the listing service 126 and/or the analytics service.

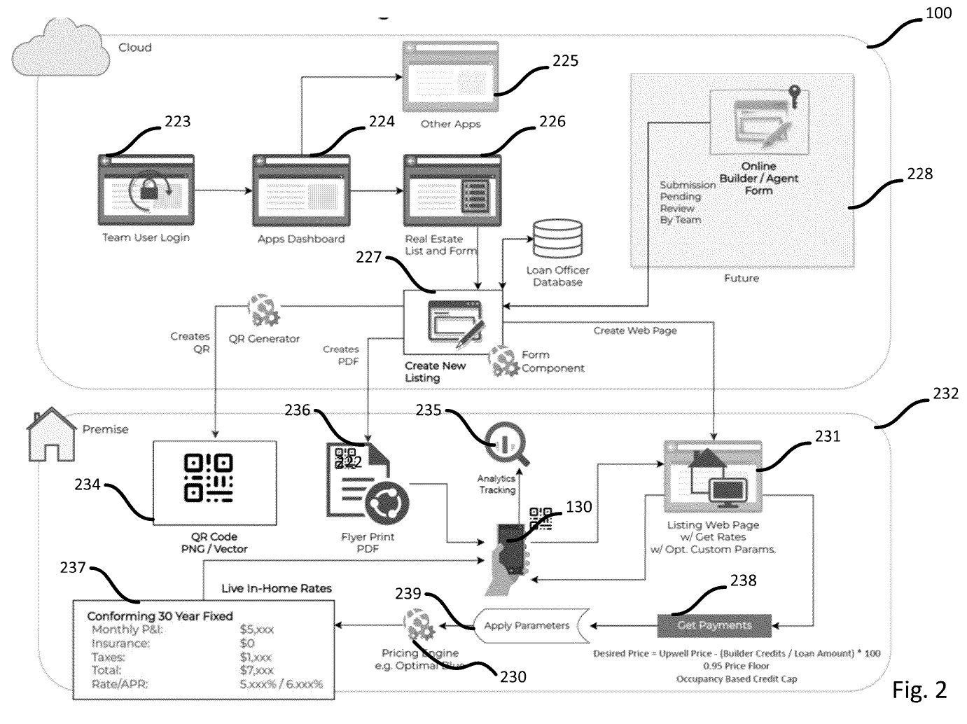

The listing service 126 provides users who may be interested in a property market with real-time rate and payment quotes that are specific to an individual property. FIG. 2 provides an embodiment of a listing service in accordance with an aspect to the disclosed subject matter. The section labeled “cloud” 100 resides in provider network 102 in an embodiment. A Team User Login page 223 provides a user interface to an apps dashboard 224 in which an administrative user can select a real estate listing from a Real Estate List 226 or select an option to Create a New Listing 227. The Create New Listing Page provides access to and online Builder/Agent Form 228. That form provides a user, e.g., a real estate agent, a builder or a representative, with access to input various data fields to create listings and to generate flyers 236. The service 100 creates codes using, e.g., QR generator, that uniquely identify the property so that a user can later quickly access the information at the property and obtain information useful in deciding whether or not to buy the property. The overall analytics system alleviates that burden on the user when comparing properties and does so in a unique way. For example, the user can compare various attributes such as how interest rates including owner or builder incentives impact the monthly costs for the buyer. Existing systems place a burden on a user which requires the user to make assumptions or to discuss the pricing with a professional. This system provides real-time pricing information based on actual rates offered on the property from, in some instances, predetermined lenders. In addition, the system factors in any incentives for an owner or builder to adjusts the incentives to provide a more competitive offering based on a monthly payment and not simply on the listing price of a property.

As also illustrated in FIG. 2, the section 232 labeled Premise provides an illustrative overview of activity that may occur at a subject property. There the user may access, for example, a QR code 234 that is displayed on a subject property. For example, the QR code 234 may be display on a printed flyer 236 having a unique QR code displayed thereon. The user upon searching the QR code will get access to a listing web page 231 containing information about the property. In addition, the user may be interested in receiving information regarding specific payments that are customized for a particular property. That payment information may be affected by competitive rate offerings pre-negotiated for a particular property and/or owner or builder incentives that may be used to lower the rate such as through a buy down of points, e.g., making a payment to reduce the interest rate.

For example, as shown in FIG. 2, after retrieving the listing by scanning the QR code, the user may further request payment information 238. That payment information will allow a user to input purchasing parameters 239, such a downpayment information and have those parameters sent along with a code identifying the particular property (e.g., by way of the QR code 234) to a pricing engine 230. Pricing engine 230 may reside in system 100 or be a separate service. The pricing engine 230 will thereafter present a real-time data set 237 indicating monthly payments, such as principal and interest, taxes, insurance, etc. That system will allow a user to make a more informed real-time decision than would otherwise be possible.

For example, the subject home is first identified by either a builder, real estate agent, or individual homeowner. That home information (address and list price) is sent to the lender. The lender then inputs several data points into the online form, also using an administrative user interface. In the alternative, the agent or another user may directly enter the data points using the administrative user interface.

In some embodiments, the data fields include:
MLS #
MLS Link to listing on agent or builder site
Subject Property Address
Property Type
# of Units
List Price
Default Down Payment
Default Loan Type
Seller or lender credit amount
Desired base price
Monthly taxes (county)
Listing Status
Loan Officer
Loan Officer contact info.
Agent Name
Agent email address
Agent Phone number

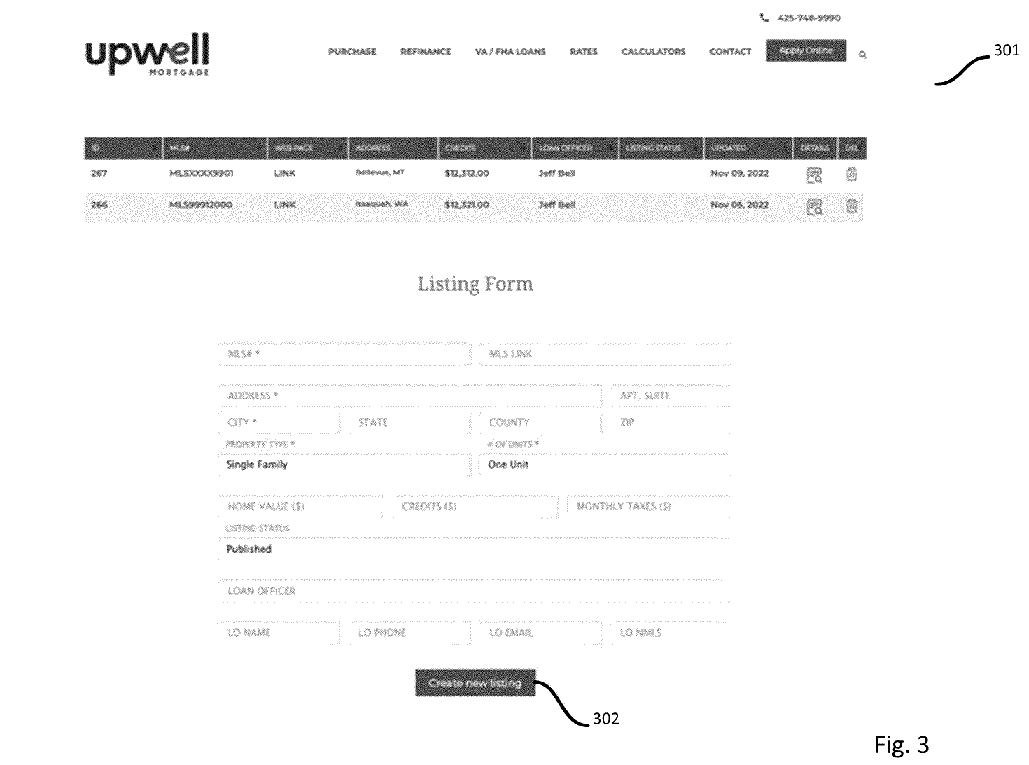

FIG. 3 illustrates one exemplary embodiment of a listing form 301. Once all fields are complete, the administrative user clicks to “Create New Listing” 302. In this embodiment, this button 302 causes the creation of three new assets:
1. Listing Page (html): The listing page is the landing page which will display default home information such as address, home price, loan amount, credit score.
2. QR Code: The QR code will direct the user to the listing page.
3. Listing Flyer (pdf): The listing flyer contains the QR code along with a message of “financing available for this home”. Details specific to the home also appear on the flyer. Those items are MLS #, address, price, loan amount, and down payment.

Referring back to FIG. 2, this Create New Listing is also illustrated by boxes 227 and 226.

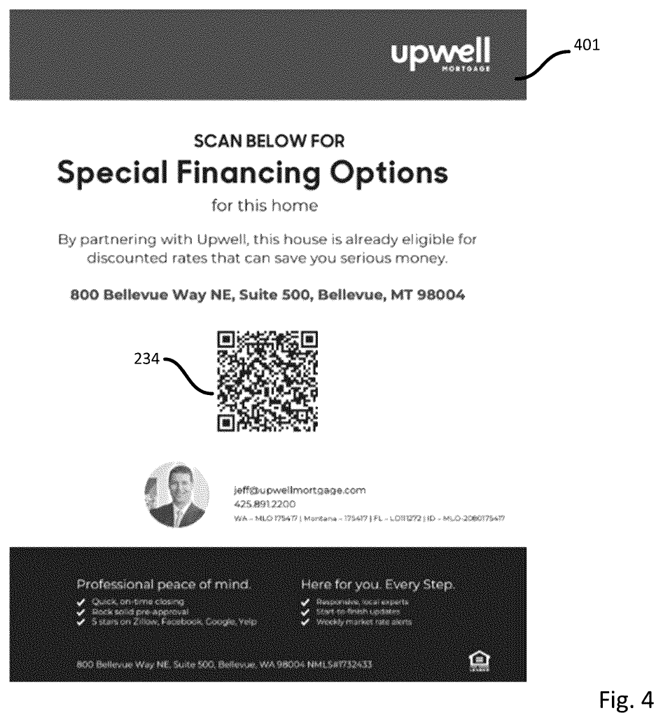

The loan officer may then email the listing flyer and QR code to an agent. FIG. 4 illustrates one example embodiment of a flyer 401 comprising a QR code 234 that may be displayed on a user's browser or printed on a flyer for presentation at a property. The agent may then print the listing flyer for display in a home and can also use the QR code for other marketing such as yard sign, agent listing flyer, or other print advertising.

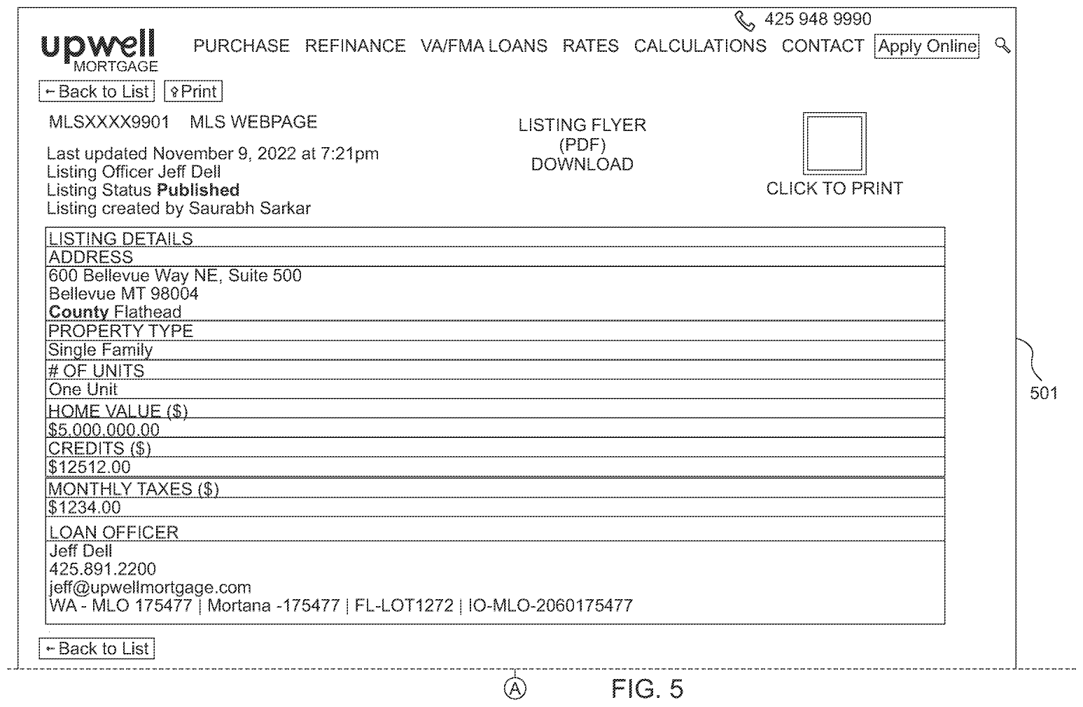

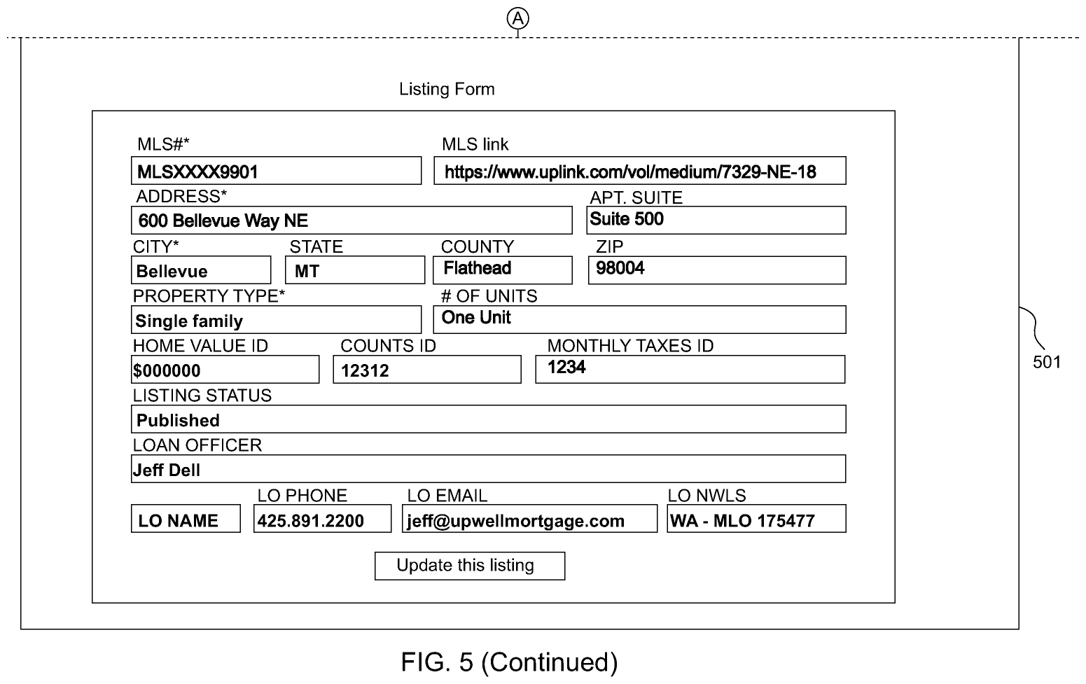

FIG. 5 illustrates an embodiment in which a user, e.g., a listing agent, has the ability to edit aspects of the listing by way of listing page 501.

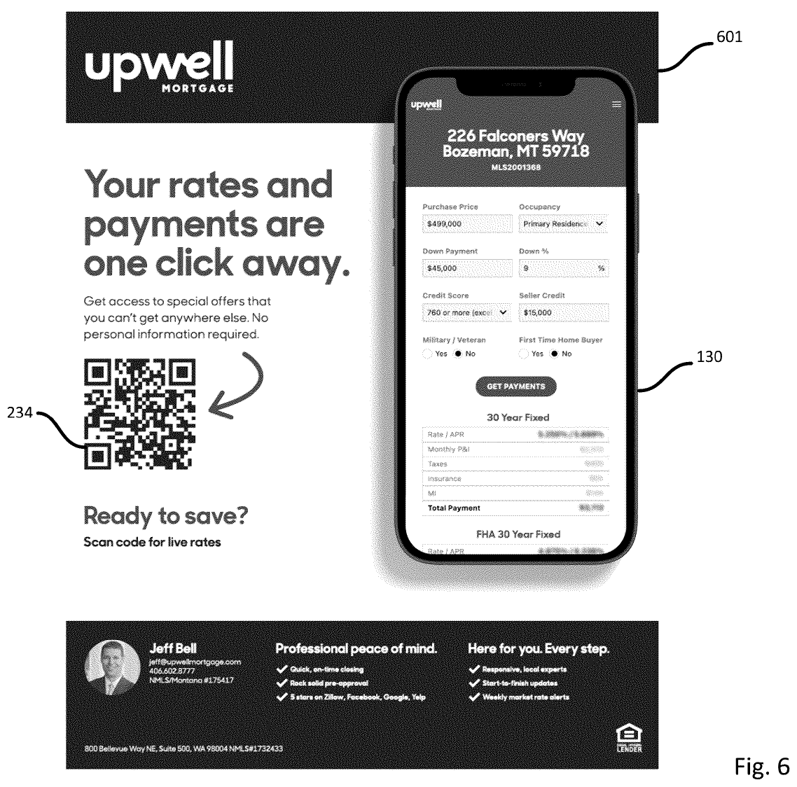

As illustrated with respect to FIG. 6, a prospective buyer touring the property, either with an agent or during an open house, can scan the QR code 234, e.g., with their personal device 130, and get directed to the listing page by the listing service where they can approve the default settings and simply “submit” for payments, or they can change any of the default settings to match their specific circumstance (i.e. adjust credit score or down payment percent). Once the form is submitted, the system makes a call to the lender pricing engine 230 (e.g., Optimal Blue) where the lenders pricing returns a rate, APR, and complete payment information. Other parameters are also applied in the background, to ensure loans maintain compliance with agency guides such as maximum allowable Interest Party Contributions (IPC's). Payment information includes principal, interest, taxes, mortgage insurance and homeowners insurance.

For listings where the seller has committed funds credited toward buyers closing costs, the price search will convert the dollar amount to a percentage of the desired loan amount. This percent “rate buydown” amount is then factored into the rate search so the response provides the rate AFTER applying the buydown. This results in a lower-than-market rate.

Searches pinging the analytics service will provide a response based on the user (loan officer) credentials that is listed on the flyer. Many companies have pricing models structured where loan officers have pricing that will be different from one another. This ensures the proper pricing is listed.

The “results” page may allow a user to change search parameters as well as call, email, or text the loan officer. Users may be able to “send results” to themselves via email. The email may contain a summary of all data points, the payments, a link back to the listing page, and LO contact information. Users have the option to edit the “seller credit” field, which may also be a credit provided by an entity other than the seller such as a lender. A “max allowable” message may be displayed if the user enters a figure that is outside the parameters of allowable Interested Party Contributions (IPC's). When the user adjusts the “seller credit” amount and selects the “Get Payments” button again, the system may recalculate the credit as a percent of the loan amount and provide updated rates that are available based on the updated credit amount. User data is tracked to identify what credit amounts buyers are more interested in for the specific home.

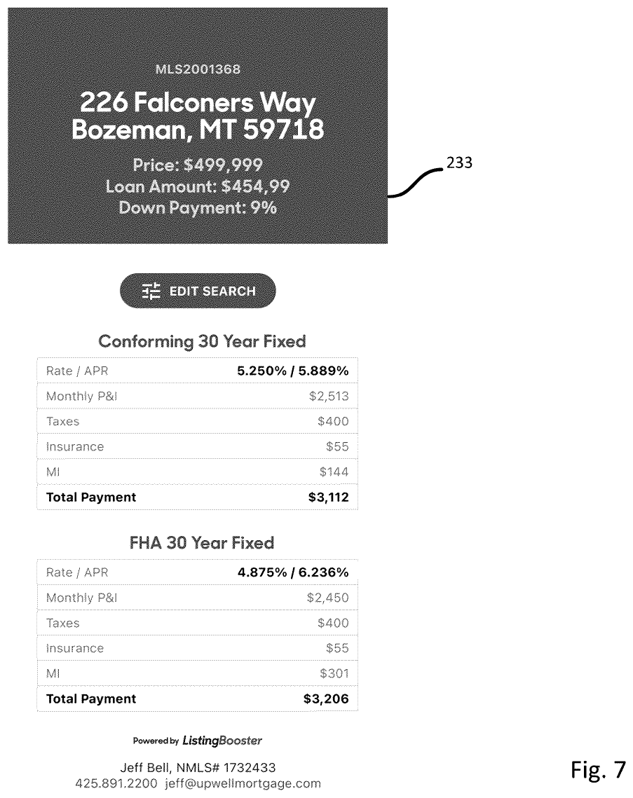

FIG. 7 provides one such results page 233 example. A sliding bar (not shown) may be presented that allow a user to increase or decrease the total payment, which will automatically adjust the down payment or seller credit amount required in order to obtain that payment.

Make an offer: The “Make an Offer” or “Buy this home” button may take the user to a new page showing the contact information for the listing agent. The user may be instructed to contact their own agent if they have a different agent that they're currently working with.

As each QR code 234 is scanned, analytics may be collected for tracking usage by listing. This is illustrated in FIG. 2 at 235 for example. Weekly emails may be sent to loan officers, agents, and builders showing a list of their active listings in the system. This allows each party to review and confirm if a listing needs to be removed or updated price and/or credit amount. In addition to data analytics for individual home listings, data analytics may also be tracked more globally. For example, the system may track pricing of homes relative to interest rates; how mortgage rate buydowns and mortgage rates are affecting sales. Does it vary from one market to another? Vary based on price of home?

When companies use the service, it may allow them the option to reduce commission as a company-provided lead, and therefore improve pricing offered thru this service. System allows “base rate” pricing to be controlled at management level rather than LO level. All of this information may be tracked by the analytics service.

The software may tie to a third-party listing provider where the listing price is automatically updated when a seller changes the price of the home.

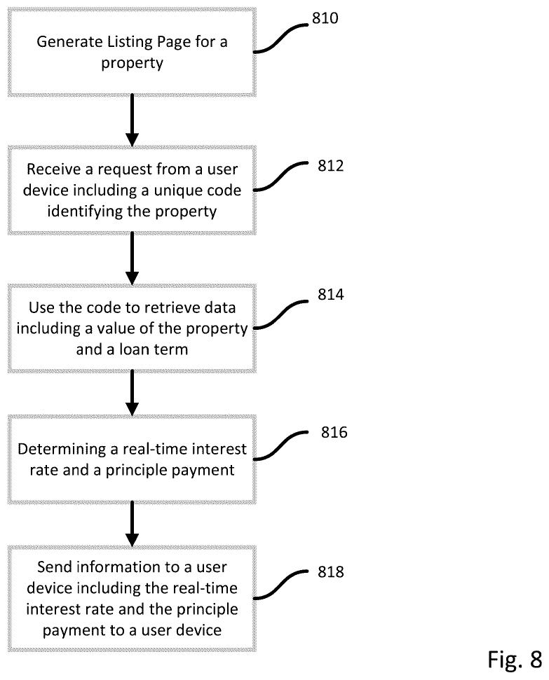

FIG. 8 presents an illustrative a flow chart of an aspect of the disclosed subject matter. At box 810, an administrative user uses, e.g., the interface shown in FIG. 3 to enter information into the analytics system, e.g., 100 of FIG. 2, to create a listing page that includes some information that uniquely identifies the property. That may include for example creating a web page and/or a flyer or brochure, electronically or hard copy, the provides information to a prospective buyer of the property.

At box 812, the analytics system receives a request from a user device. The request may have originated by a user scanning a QR code, e.g., user device 130 in FIG. 2. The scanning of the QR code would have brought up the property listing and provided a listing that gives the option to load a web page specific to the property, e.g., 231 in FIG. 2.

At box 814, that code would bring up the property listing page and given the user the ability to select the option to get loan terms and payment information (e.g., 238 in FIG. 2). The user could in some embodiments optionally add additional parameters such as loan term and downpayment information (e.g., 239 in FIG. 2).

At box 816, that information from the user would be received by the analytic system and used to determine real-time pricing information including a monthly principle and interest payment and other information such as a rate/APR adjusted based on incentives from the owner/builder of the property.

At box 818, the analytics system would send that information to e.g., user device 130 for display to the user.

As alluded to above, the analytics system may store information related to the user pricing requests. For example, the analytics system may record the number and times of the user pricing requests. The system may also correlate the requests to various changes in a listing such as a change in listing price, a change in seller/lender credits, a change in interest rates, which users continued to make an offer or a purchase of a property, and so on. Such information may be aggregated in a geographic region or for a set of properties for sale based on other factors such as price range. The collected data may be processed and provided to various administrative users so that such users can determine how various changes, e.g., changes to credits, rates, and/or pricing, affect user interest in payment requests and how many such request result in offers and/or sales.

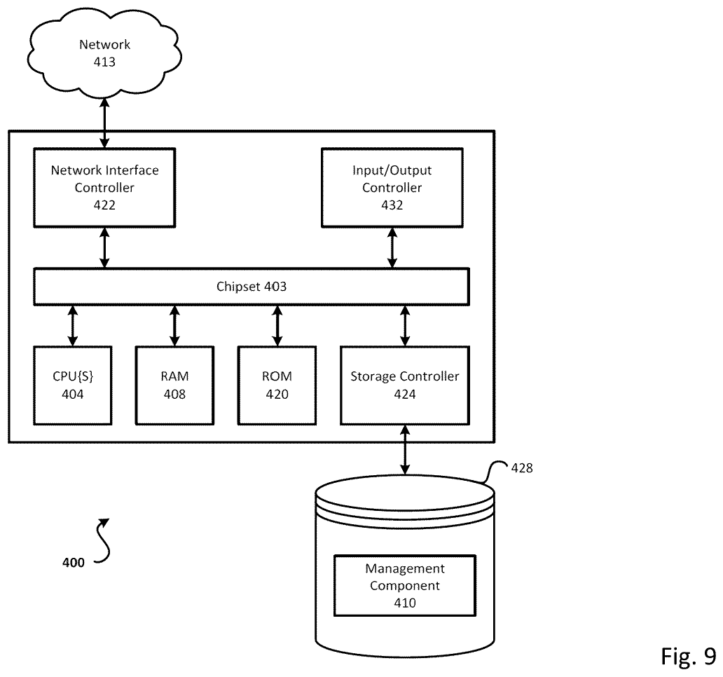

FIG. 9 depicts a computing device that may be used in various aspects, such as the services, networks, modules, and/or devices depicted in FIGS. 1-7. With regard to the example architecture and flow chart of FIGS. 1-8, the listing and/or analytics services and nodes of the provider network may be implemented by one or more instances of a computing device 400 of FIG. 9. The computer architecture shown in FIG. 9 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 400 may include a baseboard, or “motherboard,” which is a printed circuit board to which a multitude of components or devices may be connected by way of a system bus or other electrical communication paths. One or more central processing units (CPUs) 404 may operate in conjunction with a chipset 406. The CPU(s) 404 may be standard programmable processors that perform arithmetic and logical operations necessary for the operation of the computing device 400.

The CPU(s) 404 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 404 may be augmented with or replaced by other processing units, such as GPU(s). The GPU(s) may comprise processing units specialized for but not necessarily limited to highly parallel computations, such as graphics and other visualization-related processing.

A chipset 406 may provide an interface between the CPU(s) 404 and the remainder of the components and devices on the baseboard. The chipset 406 may provide an interface to a random access memory (RAM) 408 used as the main memory in the computing device 400. The chipset 406 may further provide an interface to a computer-readable storage medium, such as a read-only memory (ROM) 420 or non-volatile RAM (NVRAM) (not shown), for storing basic routines that may help to start up the computing device 400 and to transfer information between the various components and devices. ROM 420 or NVRAM may also store other software components necessary for the operation of the computing device 400 in accordance with the aspects described herein.

The computing device 400 may operate in a networked environment using logical connections to remote computing nodes and computer systems through local area network (LAN). The chipset 406 may include functionality for providing network connectivity through a network interface controller (NIC) 422, such as a gigabit Ethernet adapter. A NIC 422 may be capable of connecting the computing device 400 to other computing nodes over a network 416. It should be appreciated that multiple NICs 422 may be present in the computing device 400, connecting the computing device to other types of networks and remote computer systems.

The computing device 400 may be connected to a mass storage device 428 that provides non-volatile storage for the computer. The mass storage device 428 may store system programs, application programs, other program modules, and data, which have been described in greater detail herein. The mass storage device 428 may be connected to the computing device 400 through a storage controller 424 connected to the chipset 406. The mass storage device 428 may consist of one or more physical storage units. The mass storage device 428 may comprise a management component 410. A storage controller 424 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 400 may store data on the mass storage device 428 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 428 is characterized as primary or secondary storage and the like.

For example, the computing device 400 may store information to the mass storage device 428 by issuing instructions through a storage controller 424 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 400 may further read information from the mass storage device 428 by detecting the physical states or characteristics of one or more particular locations within the physical storage units.

In addition to the mass storage device 428 described above, the computing device 400 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 400.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 428 depicted in FIG. 4, may store an operating system utilized to control the operation of the computing device 400. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 428 may store other system or application programs and data utilized by the computing device 400.

The mass storage device 428 or other computer-readable storage media may also be encoded with computer-executable instructions, which, when loaded into the computing device 400, transforms the computing device from a general-purpose computing system into a special-purpose computer capable of implementing the aspects described herein. These computer-executable instructions transform the computing device 400 by specifying how the CPU(s) 404 transition between states, as described above. The computing device 400 may have access to computer-readable storage media storing computer-executable instructions, which, when executed by the computing device 400, may perform the methods described herein.

A computing device, such as the computing device 400 depicted in FIG. 4, may also include an input/output controller 432 for receiving and processing input from a number of input devices, such as a keyboard, a mouse, a touchpad, a touch screen, an electronic stylus, or other type of input device. Similarly, an input/output controller 432 may provide output to a display, such as a computer monitor, a flat-panel display, a digital projector, a printer, a plotter, or other type of output device. It will be appreciated that the computing device 400 may not include all of the components shown in FIG. 9, may include other components that are not explicitly shown in FIG. 9, or may utilize an architecture completely different than that shown in FIG. 9.

As described herein, a computing device may be a physical computing device, such as the computing device 400 of FIG. 9. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods. The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A property analytics system comprising:
A data store;
a non-transitory computer readable memory having stored thereon computer readable instructions;
a computing node coupled to the memory, the computing node, upon execution of the computer-readable instructions, performs operations comprising:
generating a listing page for a property, the listing page comprising details related to the property including a property value, wherein the generating of the listing page comprising generating a code for display on the listing page, the code uniquely identifying the property;
receiving a request from a user device, the requesting providing information comprising the code;
retrieving, from the data store and based on the code, data indicative of a value of the property and a loan term;
retrieving based on the code information indicative of credit assigned to the property;
causing a pricing engine to determine a principle payment based on the credit and data indicative of a real-time rate; and
sending information for display on the user device, the information comprising at least the principle payment information.

2. The property analytics system of claim 1 wherein the system is in communication with a third-party listing service to retrieve the value of the property.

3. The property analytics system of claim 1 wherein the code uniquely identifying the property is based on a QR code.

4. The property analytics system of claim 1 wherein the pricing engine adjusts the real-time rate based on the credit.

5. The property analytics system of claim 1 wherein sending information for display on the user device further comprises sending a rate adjusted by the credit.

6. The property analytics system of claim 1 comprising, after receiving the request from the user, sending for display to the user device and option to make an offer on the property.

7. The property analytics system of claim 1 further comprising collecting analytic information from the user device request among a plurality of requests from a plurality of user devices including the user device and storing the analytic information in the data store.

8. A computer-implemented method, the method comprising:
generating a listing page for a property, the listing page comprising details related to the property including a property value, wherein the generating of the listing page comprising generating a code for display on the listing page, the code uniquely identifying the property;
receiving a request from a user device, the requesting providing information comprising the code;
retrieving, from a data store and based on the code, data indicative of a value of the property and a loan term;
retrieving based on the code information indicative of credit assigned to the property;
causing a pricing engine to determine a principle payment based on the credit and data indicative of a real-time rate; and
sending information for display on the user device, the information comprising at least the principle payment information.

9. The computer-implemented method of claim 8 wherein the code uniquely identifying the property is based on a QR code.

10. The computer-implemented method of claim 8 wherein the pricing engine adjusts the real-time rate based on the credit.

11. The computer-implemented method of claim 8 wherein sending information for display on the user device further comprises sending a rate adjusted by the credit.

12. The computer-implemented method of claim 8 comprising, after receiving the request from the user, sending for display to the user device and option to make an offer on the property.

13. The computer-implemented method system of claim 8 further comprising collecting analytic information from the user device request among a plurality of requests from a plurality of user devices including the user device and storing the analytic information in the data store.

14. A non-transitory computer-readable medium having stored thereon computer-readable instructions that upon execution cause a system to perform the operations comprising:
generating a listing page for a property, the listing page comprising details related to the property including a property value, wherein the generating of the listing page comprising generating a code for display on the listing page, the code uniquely identifying the property;
receiving a request from a user device, the requesting providing information comprising the code;
retrieving, from a data store and based on the code, data indicative of a value of the property and a loan term;
retrieving based on the code information indicative of credit assigned to the property;
causing a pricing engine to determine a principle payment based on the credit and data indicative of a real-time rate; and
sending information for display on the user device, the information comprising at least the principle payment information.

15. The non-transitory computer-readable medium of claim 14 wherein the code uniquely identifying the property is based on a QR code.

16. The non-transitory computer-readable medium of claim 14 wherein the pricing engine adjusts the real-time rate based on the credit.

17. The non-transitory computer-readable medium of claim 14 wherein sending information for display on the user device further comprises sending a rate adjusted by the credit.

18. The non-transitory computer-readable medium of claim 14 comprising, after receiving the request from the user, sending for display to the user device and option to make an offer on the property.

19. The non-transitory computer-readable medium of claim 14 further comprising collecting analytic information from the user device request among a plurality of requests from a plurality of user devices including the user device and storing the analytic information in the data store.

20. The non-transitory computer-readable medium of claim 14 wherein the value of the property is retrieved from a third-party listing service.
